(19) United States
(12) Patent Application Publication
(10) Pub. No.: US 2007/0055929 A1
(43) Pub. Date: Mar. 8, 2007

(54) Templates for variable data printing

(75) Inventors: Fabio Giannetti, Bristol (GB); Alexis Cabeda, Port Alegre Rio Grande do Sul (BR); Hugo Rodriguez, Port Alegre Rio Grande do Sul (BR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/494,322

(22) Filed: Jul. 26, 2006

(30) Foreign Application Priority Data
Sep. 8, 2005 (GB) 0518261.3

(51) Int. Cl. G06F 17/00

(52) U.S. Cl. 715/517; 715/511

(57) ABSTRACT

A method, system and a computer program product for generating a variable-data printing document template 500 comprising a layout of document portions, at least one of the document portions comprising a variable portion having a shape which is variable. The document template defines multiple document versions 610,620,630, each document version being selectable in response to input selection data 640. There is provided a way of producing of variable-data publishing (VDP) documents for Digital Publishing (DP) that rely upon complex document designs containing copy-holes (document portions comprising variable content) which may be expressed according to a set of options, one of which being non-existence of the copy-hole.

### FIELD OF THE INVENTION

This invention relates to a method, system and a computer program product for generating a document template, and to a variable-data printing document template which defines multiple document versions, each document version being selectable in response to input data.

### RELATED ART

The advent of digital technology means there are now more ways than ever to communicate. This increased ability to send and receive data significantly expands an organisation's ability to deliver information via the Internet and advanced printing and publishing systems.

The combination of Web technologies and digital printing can reduce communication costs, help businesses acquire new customers, increase the loyalty and buying habits of current customers, enable new revenue opportunities, and give birth to new business models.

By gathering the right data and utilizing digital publishing an organisation can deliver information customized to their customer's wishes, when they need it. Consequently, it is no surprise that personalized, highly targeted collateral and direct marketing are widely accepted as key factors in achieving higher response rates, increased efficiencies, and improved marketing.

Digital publishing solutions enable real-time targeted marketing (RTTM) by enabling the ability to create, print on demand, and distribute marketing collateral such as brochures, presentations, direct mail and point of sale materials that are customised to each audience member in a cost effective manner. However, the value of RTTM extends beyond improved marketing response rates by helping reduce costs and drive incremental revenue.

Variable data printing (VDP) is a form of on-demand printing in which all the documents in a print run are similar but not identical. A mail merge is a simple form of VDP. For example, personalized letters may have the same basic layout, but there will be a different name and address on each letter.

Variable-data printing can now go far beyond printing different names and addresses on a document. There are systems that enable the user to insert different graphics into a document, change the layout and/or the number of pages, print a unique bar code on each document and more.

A prominent example of VDP usage is how credit-card companies analyze the buying histories of their customers and send information about specific products and services related to the ascertained customer interests. VDP systems are used to print these customized advertisements.

The concept of creating variable-data documents has also been extended to non-paper documents such as PDF documents and HTML documents. The term variable-data publishing (VDP) encompasses both paper documents and on-line documents.

Due to the resultant demands for the layout, content and personalisation of documents, high-volume print jobs are becoming more complex. In addition to this, pressure on the operators at the machines is increasing.

Personalized Print Markup Language (PPML) is the print industry's answer to these issues. PPML is a new, Extensible Markup Language (XML)-based, industry standard print language for variable data publishing (VDP). It enables high-speed, efficient printing and production of documents with reusable and variable content.

The PPML language uses XML, the Extensible Markup Language, as its syntactical base, giving it an affinity to many Web-based applications, and can access page content files generated in many different formats. Because PPML is independent of printer language, PPML can be used to create output that will support any printer language. Any PPML-compliant printer with the appropriate features will accept the same print file, no matter what software created it and what printer generates the output. Thus, applications will ultimately range from desktop to high-end digital printing presses.

The generation of VDP collateral material for Digital Publishing requires the generation of templates addressing the support for variable content and dynamic layout. Consequently, there now exists a version of PPML for variable data called PPML/T. The ‘T’ part of PPML/T corresponds to a template which is sent to the press where it can be merged with a database and a library of repeated elements to produce a PPML document.

This invention concerns in particular documents in which one document portion (“copy-hole”) has different shapes in different versions of the document. If a template defines different versions of a document that have different images located within one copy-hole, it is desirable that text content of another copy-hole should be modified to wrap around the shape of the particular image. This feature, of modifying the text to wrap around a particular shape, is known as ‘text run-around’.

Examples of documents 100,110,120 where text run-around has been enabled are illustrated in FIG. 1. The text content 130 of each of the documents 100,110,120 is wrapped around the image shapes 140,150,160 of documents 100,110,120 respectively.

Currently, when the feature of text run-around is required, the authoring tool cannot export the text portion as variable data since it is not known what the shape of the containing region is required to be. This places an undesirable restriction on the design of templates for variable data printing.

Attempts have been made to use the authoring tool to identify the run-around area and execute the text composition. However, this approach requires that the images and the text are available at design time and, as a result, the final output cannot be represented as a template.

Thus, it is desirable to generate a document template that contains content which is automatically modified according to changes in variable content.

### SUMMARY OF THE INVENTION

According to an aspect of the invention, there is provided a method of generating a variable-data printing document template in a computer readable format, the template defining multiple document versions, with each document version being selectable in response to input selection data, the method comprising: defining a template comprising a layout of document portions, at least one of the document portions comprising a variable portion having a shape which is variable; and defining a plurality of document versions, each document version comprising a unique combination of document portions, and indicating the desired variable shape of the variable portion.

According to another aspect of the invention, there is provided a method of generating a document for printing, the document comprising one version of a variable-data printing document template which defines multiple document versions and in which each document version is selectable in response to input selection data, the method comprising: generating the document template, by: defining a template comprising a layout of document portions, at least one of the document portions comprising a variable portion having a shape which is variable; and defining a plurality of document versions, each document version comprising a unique combination of document portions, and indicating the desired variable shape of the variable portion; and generating a document for printing by providing input selection data to the template which defines the document version.

According to yet another aspect of the invention, there is provided a system for generating a variable-data printing document template, the template defining multiple document versions, with each document version being selectable in response to input selection data, the system comprising: a processor which is adapted to: receive from a user a template definition comprising a layout of document portions, at least one of the document portions comprising a variable portion having a shape which is variable; receive from a user a plurality of document versions, each document version comprising a unique combination of document portions, and indicating the desired variable shape of the variable portion; and provide to a printer the document template.

According to a further aspect of the invention, there is provided a computer program for implementing a method of generating a variable-data printing document template, the program adapted to carry out the steps of: receiving user definitions defining a layout of document portions, at least one of the document portions comprising a variable portion having a shape which is variable, and further comprising a plurality of document versions, each document version comprising a unique combination of document portions, and indicating the desired variable shape of the variable portion; generating a computer readable variable data printing document template in response to the user definitions.

### BRIEF DESCRIPTION OF THE DRAWINGS

For a better understanding of the invention, embodiments will now be described, purely by way of example, with reference to the accompanying drawings, in which:

FIG. 1 illustrates the concept of text run-around within documents that contain different image shapes; and

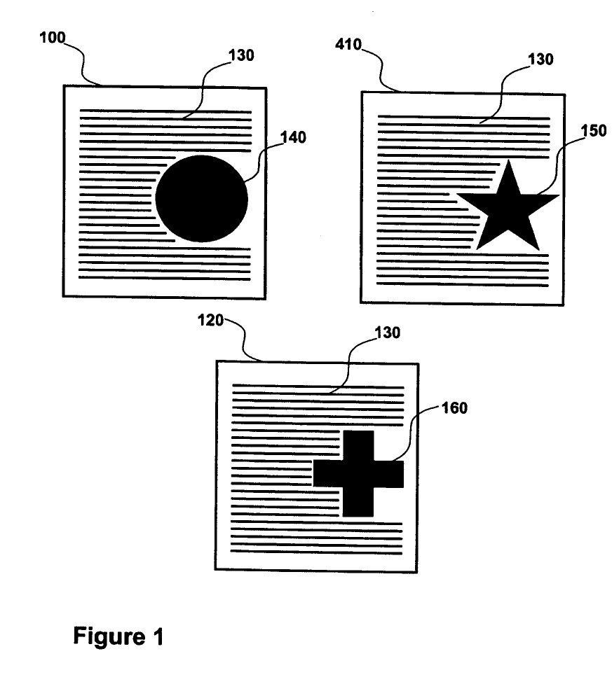

FIG. 2 shows an overview of a system proposed by the applicant for printing variable-data publishing documents from a template, the template defining multiple document versions, with each document version being selectable in response to input selection data;

FIG. 3 shows the process of generating documents using the system of FIG. 2 for printing from a template, the template defining multiple document versions, with each document version being selectable in response to input selection data;

FIG. 4 illustrates the concept proposed by the applicant of a document template defining multiple document versions, the template comprising a layout of document portions containing content which is variable;

FIG. 5 shows the process of generating a document template which defines multiple document versions, each document version being selectable in response to input selection data;

FIG. 6 shows an overview of the process of generating documents for printing from a document template, the template defining multiple document versions, with each document version being selectable in response to input data; and

FIG. 7 is a flow diagram illustrating a method of generating a document for printing according to an embodiment of the invention.

### DETAILED DESCRIPTION OF THE INVENTION

While the present invention is susceptible of embodiment in various forms, there are described and shown in the drawings presently preferred embodiments. These embodiments are provided so that this disclosure will be thorough and complete, and will fully convey the scope of the invention to those skilled in the art. Like reference numerals refer to like elements throughout.

The invention introduces a new concept of document variant which can be used to enhance the current RTTM PPML/T format by including support for copy-holes with variable shape. Copy holes with variable shape provide the possibility of designing complex interactions between images and text while maintaining the variable data binding process at a post-design stage.

This enhances the production of variable-data publishing (VDP) documents for Digital Publishing (DP) that rely upon complex document designs. Copy-holes of variable shape make the document template very flexible.

The document template can be designed with complex interactions between variable document portions, keeping the variable data binding very late in the process.

Support is provided for the arbitrary shape feature of XSL-FO that enables the text composition step at post-design. This enables the designer to simply add options to a variable and apply the standard text run-around features to the authoring tool, thus removing previous restrictions associated with design using static instances.

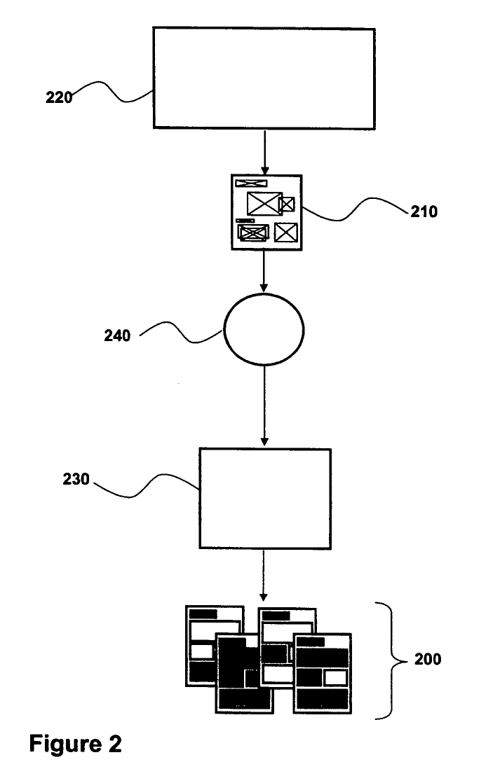

FIG. 2 shows an overview of a system proposed by the applicant for printing VDP documents 200 from a template 210, the template defining multiple document versions, with each document version being selectable in response to input selection data.

The system comprises a producer 220 and a consumer 230. The producer 220 produces VDP templates and documents for publishing by the consumer 230, the templates and documents most commonly being in PPML format. Typically, the producer 220 uses a computer based design system or graphic tool with which the document template 210 is designed.

Once the VDP template 210 is finalised, the template 210 is passed to the consumer 230, often via a marketing manager 240. In response to data provided by the marketing manager 240, the consumer 230 publishes documents 200 defined by the template 210. The consumer 230 provides means of publishing documents 200 such as a printer or digital press.

A Theme is a concept that enables different versions of a document to be generated, for example documents in different languages. These themes are implemented using multiple templates, particularly if there are variations between the copy-hole layouts.

A concept of variables with options has been introduced. A variable with option(s) is a situation where the Graphic Artist (GA) gives to a variable a fixed set of possible alternatives. A simple application can be image representing the flag of the supported languages.

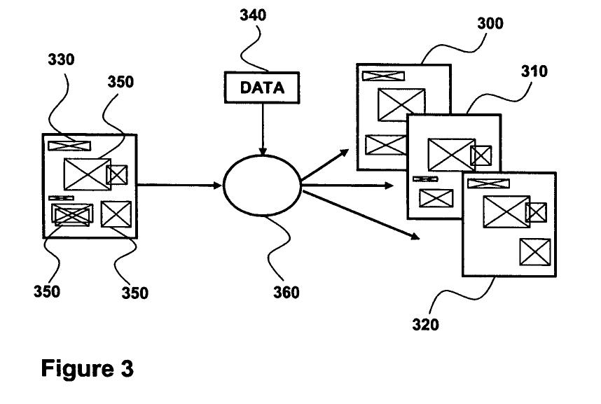

Referring to FIG. 3, the process of generating documents 300,310,320 for printing from a document template 330 which defines a document containing variable content in response to input data 340 is shown. The document template 330 comprises a layout of copy-holes 350 containing content which is variable in response to the input data 340.

The document template 330 includes the concept of a dynamic theme. A dynamic theme provides the possibility of expressing a copy-hole 350 as part of a set of options, one of which being non-existence of the copy-hole 350. For example, a dynamic theme can enable copy-holes to appear and disappear based upon rules and applied data 340.

The document template 330 is passed to a processor 360 to be merged with input data 340. The input data 340 may be a form of collated data such as, purely by way of an example, a table, a database or a spreadsheet, which defines each document version and the content to be merged into the copy-hole 350 of the document template 330 by the processor 360. The processor 360 merges data 340 with the document template 330 and renders the result to produce a document 200 comprising content in response to the data 340.

From a single document template 330, the processor 360 is able to merge the input data 240 to create a plurality of documents 300,310,320 which all contain unique layouts and content.

Using this approach, the content of the copy-holes is considered in isolation, for example a copy-hole may have image1 and image2 as options. As a result, the variable content will not change any other aspects of the design.

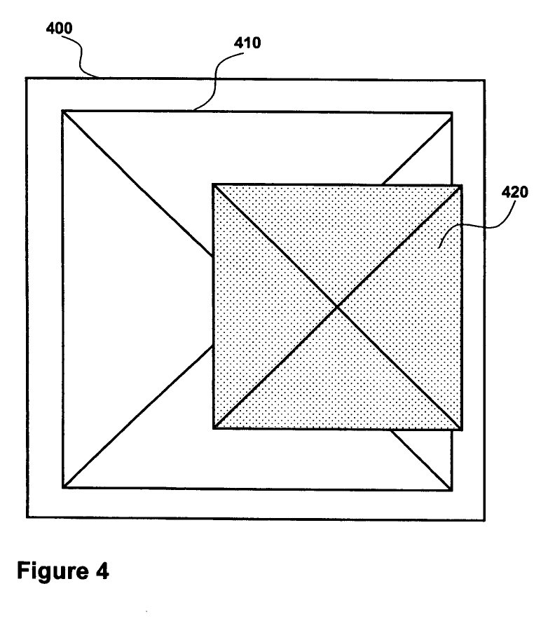

Referring to FIG. 4, a VDP document template 400 that defines multiple document versions is shown. The document template 400 comprises a layout of first and second copy-holes 410,420 containing content which is variable. A first copy-hole 410 contains text and a second copy-hole 420 contains images, the second copy-hole 420 being arranged such that it overlaps the first copy-hole 410.

If the template 400 defines different versions of a document that have different images located within the second copy-hole 420, it is desirable that the text content of the first copy-hole 410 be modified to wrap around the shape of the particular image within the second copy-hole 420. This feature, of modifying the text to wrap around a particular shape, is known as ‘text run-around’.

The GA designs a template following the principles described above, adding the feature of text run-around to the variable data for text and variable images in the manner explained above.

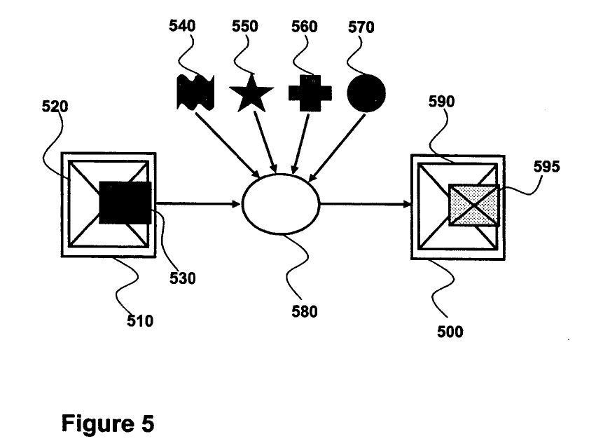

Referring to FIG. 5, the process of generating a document template 500 which defines multiple document versions, each document version being selectable in response to input selection data, is shown.

A base template 510 comprises a layout of first and second copy-holes 520,530 containing content which is variable. A first copy-hole 520 is defined as containing text and a second copy-hole 530 is defined as containing images, the second copy-hole 530 being arranged such that it overlaps the first copy-hole 520.

The images to be contained within the second copy hole 530 are separate image documents 540,550,560,570, and the second copy-hole 530 is defined such that the separate image documents 540,550,560,570, are linked to the second copy-hole 530.

The separate image documents are composed by computer based design software such as Quark xPress and Adobe InDesign, although modification may also enable the image documents to be composed by other suitable design software packages.

The design software is used to identify the contours of the images according to existing techniques implemented by the design software. The design software traces the background color for the image and identifies the shapes of the regions that may contain text. The image documents are exported from the design software as Extensible Stylesheet Language Formatting Object (XSL-FO) documents 540,550,560,570 containing information relating to the regions that may contain text.

XSL-FO is an XML based markup language describing the formatting of XML data for output to screen, paper or other media.

The base template 510 includes the concept of dynamic themes explained above so that it provides the possibility of expressing a copy-hole 530 as part of a set of options, one of which being the non-existence of the copy hole 530. For example, a dynamic theme can enable copy-holes to appear and disappear based upon rules and applied data.

Using the concept of themes, the various options relating to the images to be contained by the second copy-hole 530 is connected to the shape selection for the XSL-FO content. Thus, the image content of the second copy-hole 530 can vary according to the personalization defined by the various options.

The base template 510 and XSL-FO image documents 540,550,560,570 are processed by a processor 580 and exported to create single document template 500 which defines multiple document versions and is provided in a computer readable format.

When the template is exported, an exporting plug-in replaces all the available images as options and calculates the associated run-around boundaries for the copy-hole 520. The resultant template 500 comprises a layout of copy-holes 590,595 which have a shape that is variable and contain content which is variable. Thus, the document template 500 contains many variants that would otherwise require different templates.

The invention uses the concept of themes to automatically group variables with options, for example representing the image and the resulting boundary shape. When a rule is applied to select a required image, the corresponding boundary shape is automatically selected and a rendering engine can then complete the task of text composition within the defined boundaries.

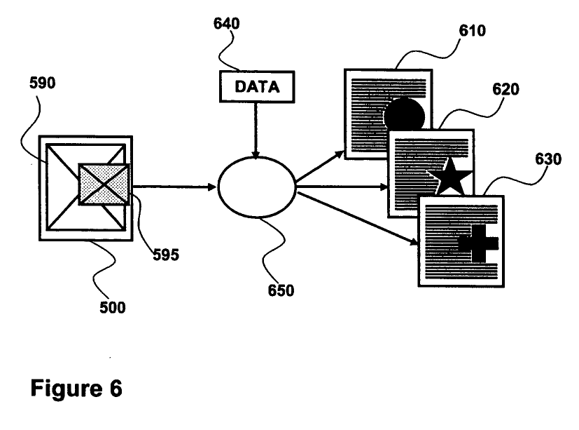

FIG. 6 shows an overview of the process of generating documents 610,620,630 for printing from a document template 500, the template defining multiple document versions, with each document version being selectable in response to input data 640. The document template 500 comprises a layout of copy-holes 590,595 which have a shape that is variable and contain content which is variable, their shape and content being selectable in response to the input data 640.

The document template 500 is passed to a processor 650 to be merged with input data 640. The input data may be a form of collated data such as, purely by way of an example, a table, a database, or a spreadsheet, which defines each document version and the content to be merged into the copy-holes 590,595 by the processor 650. The processor 650 merges data 640 with the document template 500 and renders the result to produce a document 610 comprising content in response to the data 640.

In the case of document 610, where the applied data 640 and rules select the circular image 570 to be placed within the second copy-hole 595, the associated run-around boundaries for the adjacent text copy-hole 520 are automatically selected and an XSL-FO rendering engine within the processor 650 completes the task of text composition within the defined boundaries.

The input data 640 can be represented using Extensible Markup Language (XML). Since XML is a cross-platform, software and hardware independent tool for transmitting information, data represented as XML can be exchanged between incompatible systems. Accordingly, use of XML can greatly reduce the complexity of exchanging the data 630.

From a single document template 500, the processor 650 is able to merge the input data 640 to create a plurality of documents 610,620,630 that all contain unique layouts and content, the document template 500 allowing for the representation of complex interactions between the content.

As an example, referring back to FIG. 5, the GA may wish to provide the option of either the image of a circle 570 or the image of a star 550 appearing in the second copy-hole 530. The image options may be represented as follows:

```
<ppml:REUSABLE_OBJECT>
  <ppml:OBJECT Position=“0 0”>
    <ppml:SOURCE Dimensions=“W1 H1” Format=“image/jpeg”>
      <ppml:EXTERNAL_DATA Src=“Images/circle.jpg”/>
    </ppml:SOURCE>
  </ppml:OBJECT>
  <ppml:OCCURRENCE_LIST>
    <ppml:OCCURRENCE Name=“Circle” Environment=“DM”
    Scope=“Job”>
  </ppml:OCCURRENCE_LIST>
</ppml:REUSABLE_OBJECT>
<ppml:REUSABLE_OBJECT>
  <ppml:OBJECT Position=“0 0”>
    <ppml:SOURCE Dimensions=“W2 H2” Format=“image/jpeg”>
      <ppml:EXTERNAL_DATA Src=“Images/star.jpg”/>
    </ppml:SOURCE>
  </ppml:OBJECT>
  <ppml:OCCURRENCE_LIST>
    <ppml:OCCURRENCE Name=“Star” Environment=“DM”
    Scope=“Job”/>
  </ppml:OCCURRENCE_LIST>
</ppml:REUSABLE_OBJECT>
<ppml:MARK Position=“X1 Y1”>
  <ppml:OCCURRENCE_REF Environment=“DM”>
    <xsl:attribute name=“Ref”>
      <xsl:choose>
        <xsl:when test=“(Image=‘Option_1’)”>Circle</xsl:when>
        <xsl:when test=“(Image=‘Option_2’)”>Star</xsl:when>
      </xsl:choose>
    </xsl:attribute>
  </ppml:OCCURRENCE_REF>
</ppml:MARK>
```

The above example demonstrates code to describe two image options, defining the images using the known concept of re-usable objects available in PPML. Object one is an image of a circle, defined by the file “circle.jpg”, which is a reusable object with the dimensions of width and height defined as W1 and H1 respectively. Similarly, object two is an image of a star, defined by the file “star.jpg”, which is a reusable object with the dimensions of width and height defined as W2 and H2 respectively. These jpg files are reusable objects.

The <xsl:when> test is used to establish whether the respective image should be selected when the variable data is merged and the “Image” theme is evaluated according to business rules created at a post-design phase. For example, the image of circle will be selected if the value of ‘Image’ equals ‘Option_{—}1’. Thus, the <xsl:choose> construct simply selects different theme options in response to external data.

The program code uses standard XSL tags as defined by the World Wide Web Consortium (W3C). These will be well known to those skilled in the art and accordingly are not described in detail.

In order to adapt the shape of a copy-hole, or execute the feature of text run-around, it is required to express the same theme options in the copy-hole containing an extended version of the XSL-FO for the description. For example, the options for the shape of the copy-hole can be expressed within the description of the copy-hole as follows:

```
<fo:complex-page-master master-name=“copy-hole”>
  <fo:arbitrary-region region-name=“run-around”>
    <xsl:choose>
      <xsl:when test=“(Image=‘Option_1’)”>
        <!-Shape 1 Path -->
        <svg:path d=“...circle path ... ”/>
      </xsl:when>
      <xsl:when test=“(Image=‘Option_2’)”>
        <!-Shape 2 Path -->
        <svg:path d=“...star path...”/>
      </xsl:when>
    </xsl:choose>
  </fo:arbitrary-region>
</fo:complex-page>
```

The above code defines shape where the text is to be wrapped for each image options. In more detail, if the value of ‘Image’ equals ‘Option_{—}1’, the shape where the text is to be wrapped is set according to the XSL-FO path description of the selected circle. Similarly, if the value of ‘Image’ equals ‘Option_{—}2’, the shape where the text is to be wrapped is set according to the XSL-FO path description of the selected star.

Furthermore, this can also be extended to the use of a non-existence option. A particular copy-hole can have different options for the content as previously shown and can also be present or not according to the rules. In this case, adding, to the corresponding selection mechanisms, the possibility of not having the image copy-hole and a simple square region for the XSL-FO text, can extend the concept. This can be implemented utilising the <xsl:choose> construct in a similar manner to that as described above, arranging the code to provide for a selection between the existence or non-existence of a copy-hole.

Rules that trigger the various options in the template can be formulated, the rules enabling particular options of a theme. These theme options can be described at design time and saved in a section of the PPML/T template 500.

Since the theme options are defined as design-time, there is no need for the GA to bind real data with the theme options in order to produce a final document for exporting to print.

The example of the invention described above enables the feature of text run-around in the case of variable text with a group of graphical insets that can vary in shape and can exist or not exist depending on particular rules. As a result, the number of necessary templates to be generated at design time is reduced since options with or without run-around are supported. Also, within the run-around case, pre-defined options are supported.

Thus, it is to be appreciated that embodiments of the invention provide a method for generating a variable-data printing document template in a computer readable format, the template defining multiple document versions, with each document version being selectable in response to input selection data. In addition, alternative embodiments provide a method of generating a document for printing, the document comprising one version of a variable-data printing document template.

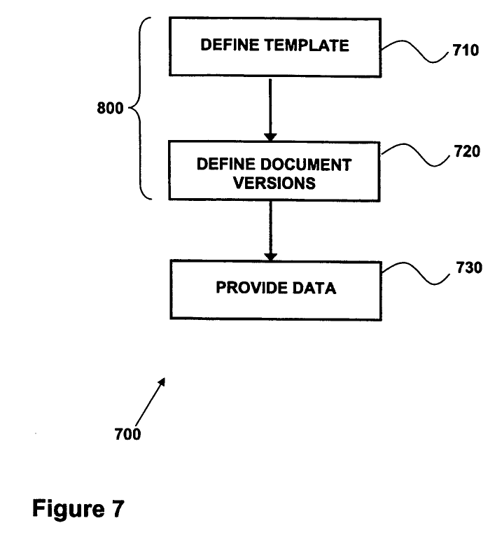

Referring now to FIG. 7, a flow diagram is shown that illustrates a method of generating a document for printing according to an embodiment of the invention. The document comprises one version of a variable-data printing document template which defines multiple document versions, each document version being selectable in response to input selection data. The method is indicated generally by arrow 700 and comprises method steps 710 to 730.

Step 710 comprises defining a template comprising a layout of document portions, at least one of the document portions comprising a variable portion having a shape which is variable.

In step 720, a plurality of document versions are defined and the desired variable shape of the variable portion is indicated. Each document version defined comprises a unique combination of document portions.

In step 730, a document for printing is generated by providing input selection data to the document template which defines the document version.

It may also be appreciated that a method for generating a variable-data printing document template, indicated generally by 800, is provided by steps 710 and 720 of FIG. 7. In response to the input selection data which defines the document version, a document may therefore be generated from a template provided by method 800.

Even though the invention has been presented in the context of an image choice application, it is simple to foresee the invention applied to a variety of situations where document templates for VDP are required.

The invention can be implemented as a GA tool to represent documents composed by computer based design software such as Quark xPress and Adobe InDesign. Further modification may also enable the invention to be incorporated into existing VDP software and systems.

Those skilled in the art will realise that the above embodiments are purely by way of example and that modification and alterations are numerous and may be made while retaining the teachings of the invention.

We claim:

1. A method of generating a variable-data printing document template in a computer readable format, the template defining multiple document versions, with each document version being selectable in response to input selection data, the method comprising:
defining a template comprising a layout of document portions, at least one of the document portions comprising a variable portion having a shape which is variable; and
defining a plurality of document versions, each document version comprising a unique combination of document portions, and indicating the desired variable shape of the variable portion.

2. A method as claimed in claim 1 wherein at least one variable portion does not contain any content in response to the input selection data.

3. A method as claimed in claim 1 wherein the generation from the variable-data printing document template in response to the input selection data is based upon rules which define the document version.

4. A method as claimed in claim 1 wherein a visual display unit is provided and the method further comprises:
the on-screen visualization of unique combinations of document portions on the single variable-data printing document template by selecting the non-existence of a unique combination of document portions.

5. A method as claimed in claim 1 wherein the variable-data printing document template is represented as a Personalized Print Markup Language Template (PPML/T).

6. A method as claimed in claim 1 wherein the input selection data comprises data represented as Extensible Markup Language (XML).

7. A method as claimed in claim 1 wherein the location of at least one of the document portions is variable in response to the input selection data which defines the document version.

8. A method as claimed in claim 1 wherein the size of at least one of the document portions is variable in response to the input selection data which defines the document version.

9. A method of generating a document for printing, the document comprising one version of a variable-data printing document template which defines multiple document versions and in which each document version is selectable in response to input selection data, the method comprising:
generating the document template, by:
defining a template comprising a layout of document portions, at least one of the document portions comprising a variable portion having a shape which is variable; and
defining a plurality of document versions, each document version comprising a unique combination of document portions, and indicating the desired variable shape of the variable portion; and
generating a document for printing by providing input selection data to the template which defines the document version.

10. A method as claimed in claim 9 wherein the step of generating a document for printing further comprises wrapping the shape of the variable portion around a document portion in response to the input selection data.

11. A method as claimed in claim 10 wherein the variable portion comprises text content.

12. A method as claimed in claim 9 further comprising:
defining rules that depict the document version in response to the input selection data.

13. A method as claimed in claim 9 wherein a visual display unit is provided and the method further comprises:
the visualization of each unique combination of document portions on the single template by selecting the non-existence of a unique combination of document portions.

14. A method as claimed in claim 9 wherein the variable-data printing document template is represented as a Personalized Print Markup Language Template (PPML/T).

15. A method as claimed in claim 9 wherein the input selection comprises data represented as Extensible Markup Language (XML).

16. A method as claimed in claim 9 wherein the location of at least one of the document portions is variable in response to the input selection data which defines the document version.

17. A method as claimed in claim 9 wherein the size of at least one of the document portions is variable in response to the input selection data which defines the document version.

18. A system for generating a variable-data printing document template, the template defining multiple document versions, with each document version being selectable in response to input selection data, the system comprising:
a processor which is adapted to:
receive from a user a template definition comprising a layout of document portions, at least one of the document portions comprising a variable portion having a shape which is variable;
receive from a user a plurality of document versions, each document version comprising a unique combination of document portions, and indicating the desired variable shape of the variable portion; and
provide to a printer the document template.

19. A system as claimed in claim 18, further comprising a printer, which is adapted to receive input selection data which defines a document version, and generate from the input selection data and the document template a document version.

20. A system as claimed in claim 18, wherein in the generated document version the shape of the variable portion wraps around a document portion.

21. A system as claimed in claim 18, wherein the variable portion comprises text content.

22. A computer program for implementing a method of generating a variable-data printing document template, the program adapted to carry out the steps of:
receiving user definitions defining a layout of document portions, at least one of the document portions comprising a variable portion having a shape which is variable, and further comprising a plurality of document versions, each document version comprising a unique combination of document portions, and indicating the desired variable shape of the variable portion;
generating a computer readable variable data printing document template in response to the user definitions.

23. A computer program according to claim 22 wherein the computer readable variable data printing document template is represented as a Personalized Print Markup Language Template (PPML/T).

24. A computer program according to claim 22 further adapted to generate a document from the variable data printing document template in response to input data which defines the document content.
